(19) United States
(12) Patent Application Publication
(10) Pub. No.: US 2013/0133056 A1
(43) Pub. Date: May 23, 2013

(54) Single login Identifier Used Across Multiple Shopping Sites

(71) Applicant: Matthew Christian Taylor, Menlo Park, CA (US)

(72) Inventor: Matthew Christian Taylor, Menlo Park, CA (US)

(21) Appl. No.: 13/301,508

(22) Filed: Nov. 21, 2011

(51) Int. Cl. H04L 9/32

(52) U.S. Cl. 726/8

(57) ABSTRACT

Various methods and systems for facilitating online shopping at multiple retailer websites using a single login identifier are provided. The techniques disclosed herein allow prospective consumers to access various retailer websites on the Internet without the need to remember multiple logins and passwords or log into such retailer websites each time the consumers uses a new electronic device. The prospective consumers may log into a common website, such as a social networking website using a single user identifier and password. An example method for facilitating online shopping at multiple retailer websites using a single login identifier comprises receipt of the login information that corresponds to one or more login websites from a user device. The method may further include retrieving an internal user login identifier based on the received login information.

### TECHNICAL FIELD

This disclosure relates generally to electronic shopping technologies. More particularly, the present disclosure relates to methods and systems for facilitating online shopping at multiple retailer websites using a single login identifier.

### DESCRIPTION OF RELATED ART

Online shopping is a popular way to purchase products and services through the Internet. It is a continuously growing field of commerce, also known as E-commerce. Recent developments and improvements in various Internet technologies have made it possible to simplify the process of online retail services, marketing, and information sharing for both consumers and merchants.

Today, many retailers have their own associated websites, which enable consumers to purchase products or services online. In certain cases, some retail websites are directed to resell third-party products or services. Conventionally, retail websites provide detailed information on products or services that are offered for sale. Such information normally includes images, descriptions, prices, availability, shipping and delivery information, various audio/video content, including marketing related data, and so forth.

Consumers may use a web browser to review product/service related information, order or purchase products or services, communicate with a retailer's representative, to name a few. Typically, various retail websites require that consumers register with their websites before any purchase is made. This facilitates the process of purchasing products/services from a retailer's website by eliminating the need to provide payment details and billing and shipping addresses each time a new purchase is made. On the other hand, people usually do online shopping on multiple various retailer websites. Each of these retailer websites requires that a prospective consumer is logged in or registered before any purchase is made, which is inconvenient for consumers. Moreover, due to retailers' varying requirements, consumers have to remember a number of different login identifiers and passwords to access their websites. Having to remember multiple various login identifiers and passwords can be difficult and inconvenient.

To some extent, this problem can be resolved by storing web cookies on the consumer's device. Web cookies may be used to automatically log users into a website based on the state information, stored during their previous visit. However, web cookies are tied to specific computers, and, therefore unavailable to other computer the user may utilize. For example, if a user has logged into a retailer website to make a purchase using their home Personal Computer (PC), the stored web cookies would be unavailable on their smart phone or office computer. Consequently, to continue shopping at the same retailer website, the user would need to log in to the website each time they start using a new device. This process can be inconvenient and annoying as people normally use several different electronic devices to access the Internet in their day-to-day activities. Overall, the online shopping technologies are only marginally improved, while a plethora of additional problems is created.

While people dedicate some of their time to online shopping, they spend even more time visiting social networking websites, gaming sites, and other similar sites. In some ways, these sites compete with online retailers for the time users spend online. At the same time, social networking websites provide a good platform for advertising products and services, sharing marketing information between members of these websites, and even completing purchasing transactions.

### SUMMARY

This summary is provided to introduce a selection of concepts in a simplified form that are further described below in the Detailed Description. This summary is not intended to identify the key or essential features of the claimed subject matter, nor is it intended to be used as an aid in determining the scope of the claimed subject matter.

In accordance with the various embodiments and the corresponding disclosures thereof, methods and systems for facilitating online shopping at multiple retailer websites using a single login identifier are provided. In particular, the provided techniques allow prospective consumers to access various retailer websites on the Internet without the necessity to remember multiple logins and passwords, while also eliminating the need to log into such retailer websites each time the consumers use a different device. More specifically, the prospective consumers only need to log into a “common” website using a single user identifier and password.

This “common” website, also referred to as a login website, may be a social networking website, a storefront website, or any other website. The common website may also provide to the consumers a shared shopping cart supported by multiple retailers. Correspondingly, a single login to the common website allows the consumers to navigate the websites and transact with multiple online retailers without ever leaving this common website. In accordance with some embodiments, the common website serves as a virtual platform to embed multiple retailer websites in such a way that the consumers need to access the common site only. In some other exemplary embodiments, once the login identifier and password for a certain consumer have been received, the common website may also provide a functionality to access some other retailer websites without a necessity the need to log into these websites.

Furthermore, there is no need for the consumers to provide payment or shipping information to multiple retailers. The afore-mentioned shared shopping cart may be linked to the user's login information and stored by the common website even after the consumer leaves this website. In other words, the consumer may select some products, add them to the shared shopping cart, and then log out. As the consumer logs in again, the contents of the shared shopping cart remain the same even if the cart is accessed from another computer. The consumer may then continue online shopping.

In certain embodiments, the method for facilitating online shopping at multiple retailer websites using a single login identifier involves receiving login information from a user device. The login information may correspond to one or more login web sites (or the “common” website mentioned above). The login website may be a social networking site. If this is the case, the login information may correspond to a social identifier (ID). However, in some other embodiments, the login website may be a storefront website or any other website in the Internet.

The login operation may be followed by a user authentication procedure based on the received login information. In case the identification is successful, the method may proceed to the operation when an internal user login identifier is retrieved based on the received login information. The internal user login identifier may be retrieved from a database by determining the correspondence between the internal user login identifier and various login information related to multiple different websites. For example, when the user provides their login information related to a social networking site, the method may return a corresponding internal user login identifier related to one or more retailer websites.

The method may then proceed with generating a shared shopping cart virtually associated with the internal user login identifier. In various embodiments, the shared shopping cart may be used for purchasing product items from multiple retailer websites. The shared shopping cart is linked to the internal user login identifier and may be retained by the login website even after the user leaves the website.

The method may involve retrieving information on at least one product item, previously added by the user to the shared shopping cart during one or more previous user sessions. If there are any, such product items may be added to the shared shopping cart. Accordingly, the user may continue online shopping after they pause to change the user devices that were used to access the login website.

Thereafter, the method may proceed to display the product information that corresponds to one or more product items based on the internal user login identifier. The information may be displayed on the login website or any other affiliated website depending on the application. Accordingly, the user is enabled to review the products and make online purchase decisions. The user may select one or more products items and “put” them into the shared shopping cart. In this case, the login website, or any other affiliated website, correspondingly, may receive the product item identifications from at least one retailer website. The product identifications may correspond (in other words, be linked) to the internal user login identifier to track such user selections. The product item or items, associated with the product identifications, are then added to the shared shopping cart. The product items may be retained in the shared shopping cart for a predefined period of time.

In certain embodiments, the method may also include receiving and processing payment information associated with the product items added to the shared shopping cart. The payment information may also be associated with the internal user login identifier. The afore-mentioned receipt and processing of the payment information may comprise sending the payment and product identification information to a third-party payment system for further processing.

In addition, a system for facilitating online shopping at multiple retailer websites using a single login identifier is provided. The system may comprise at least a communication module, configured to receive login information from a user device, an authenticating module, configured to retrieve an internal user login identifier based on the received login information, and a processing module, configured to generate a shared shopping cart, virtually associated with the internal user login identifier.

Provided is also a computer-readable medium having instructions stored thereon, which, when executed by one or more computers, may cause these computers to implement the method for facilitating online shopping at multiple retailer websites using a single login identifier as disclosed above.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

Embodiments are illustrated by way of example and not limitation in the figures of the accompanying drawings, in which like references indicate similar elements.

FIG. 1 shows a block diagram illustrating a system environment suitable for facilitating online shopping at multiple retailer websites using a single login identifier.

FIG. 2 is a diagram of online shopping system.

FIG. 3 is a process flow diagram showing a method for facilitating online shopping at multiple retailer websites using a single login identifier.

FIG. 4 shows an exemplary embodiment of a concordance table used in the member database.

FIG. 5 is a simplified illustration of a graphical user interface of an online shopping site hosted by the online shopping system.

FIG. 6 is a simplified illustration of a graphical user interface of an online shopping site hosted by the online shopping system.

FIG. 7 is a diagrammatic representation of an example computer in the form of a computer system within which a set of instructions, for the computer to perform any one or more of the methodologies discussed herein, is executed.

### DETAILED DESCRIPTION

The following detailed description includes references to the accompanying drawings, which form a part of the detailed description. The drawings show illustrations in accordance with exemplary embodiments. These exemplary embodiments, herein also referred to as “examples,” are described in sufficient detail to enable those skilled in the art to practice the present subject matter. The embodiments may be combined, other embodiments may be utilized, or structural, logical and electrical changes may be made without departing from the scope of what is claimed. The following detailed description is, therefore, not to be taken in a limiting sense, and the scope is defined by the appended claims and their equivalents. In this document, the terms “a” and “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

The techniques of the embodiments disclosed herein might be implemented using a variety of technologies. For example, the methods described herein may be implemented in software on a computer system or in hardware, utilizing either a combination of microprocessors, or other specially designed application-specific integrated circuits (ASICs), programmable logic devices, or various combinations thereof. In particular, the methods described herein may be implemented by a series of computer-executable instructions residing on a storage medium such as a carrier wave, disk drive, or computer-readable medium. Exemplary forms of carrier waves may take the form of electrical, electromagnetic, or optical signals conveying digital data streams through a local network, or a publicly accessible network such as the Internet.

The embodiments described herein relate to computer-implemented methods and systems for facilitating online shopping at multiple retailer websites using a single login identifier. An architecture within which these methods and systems are implemented may include, among other components, one or more servers and one or more client devices operatively coupled via a network. One example of a client-server environment is the Internet, although any other appropriate type of client-server environments, such as an intranet, a wireless network, a telephone network, etc., may also be used.

The client device may include a PC, a network computer, a laptop, a tablet computer, a cellular telephone, a smart phone, a PDA, or any other computing device with ability to interact with a remote web server over a network such as the Internet.

In accordance with various embodiments, the servers may host websites such as a login website and a retailer website. The login website may be utilized as a virtual platform to access some other information from other web pages or websites. Thus, the login website allows integrating multiple online merchants under one umbrella. Such integration, in turn, allows users to log into the login website only rather than logging into multiple retail websites. In this case, the user may use a single login identifier and a password without the necessity to remember different login information from multiple retailer websites.

The login website may be any website that is frequently used by users for various purposes, such as online shopping and other purposes. The login website may be a social media site such as, for example, a social networking site, a blog, a micro-blog, a podcast, a chat, a content sharing system, and so forth. Typically, social media sites provide mechanisms for their members to communicate with each other, form connections with each other, store information, share information of interest, among other things. In use, members may join social media networks and then add connections to a number of other members to whom they desire to be connected. Traditionally, such connected members are also known as social network friends, or simply “friends”.

Social networking websites and blogging websites maintain member profiles for each member. The member profiles may comprise personal information, including names, nicknames, representative pictures, lists of friends, and so forth. The member profiles may also be associated with login information, which allows for authentication purposes. Various social media sites may also comprise Application Programming Interfaces (APIs) to enable multiple other applications and websites to gain access to the information associated with the various member profiles.

When a user logs in to the login website such as a social networking website, a shared shopping cart is assigned to the user. The shared shopping cart may be used to add or remove product items from any retailer website associated with the login website. The payment may be processed by the login website or a third-party payment service. The online retailers then receive their shares of the payment from the login website or the third-party payment service.

In addition, the afore-mentioned shared shopping cart may virtually link multiple shopping destinations. Therefore, the user may shop from multiple online retailers using the same shopping cart. The user may add one product item to the shared cart from one store and then make purchases from a completely different online store using the same shopping cart. In other words, a user has a cart that “belongs” to different merchants.

Furthermore, according to various embodiments disclosed herein, the shared shopping cart may be linked to login information. In particular, it may be linked to an internal user login identifier, which is associated with the login website. In other words, the user may login using any known login information related, for example, to a social networking site or a gaming site (the “login website”). The provided login information is then automatically processed to retrieve a corresponding internal user login identifier related to this user. All product items added to the shared shopping cart are virtually linked to this internal user login identifier.

Therefore, technically, shared shopping carts cannot be abandoned. When a user leaves the login website and then re-enters the login website, the contents of the shopping cart are saved so that the user may continue with their online shopping. In addition, the users may use various computer systems (e.g., a work computer, a cell phone, a home computer) to log in and continue with their online shopping. Overall, a shared shopping cart recognizes a user based on the login information, which is different from placing web cookies on the user device.

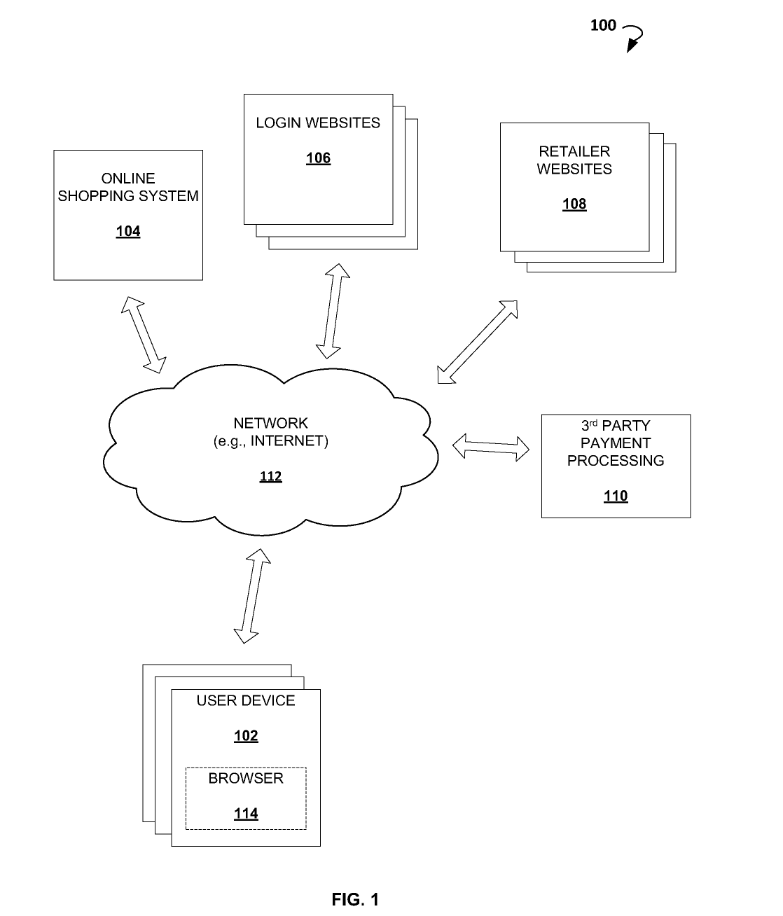

Referring now to the drawings, FIG. 1 shows a block diagram illustrating a system environment 100 suitable for facilitating online shopping at multiple retailer websites using a single login identifier. The system environment 100 comprises one or more user devices 102, an online shopping system 104, one or more login websites 106, one or more retailer websites 108, one or more third-party payment processing systems 110, and a network 112. The network 112 may couple the aforementioned modules.

The network 112 is a network of data processing nodes interconnected for the purpose of data communication that may be utilized to couple various components of the system environment 100. The network 112 may include the Internet or any other network capable of communicating data between devices. Suitable networks may include, or interface with any one or more of, for instance: a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port, such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, the communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS, CDPD (cellular digital packet data), RIM (Research in Motion, Limited) duplex paging network, Bluetooth radio, or an IEEE 802.11-based radio frequency network. The network 112 may further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

The user device 102 may refer to a computer, a laptop, a tablet computer, a portable computing device, a PDA, a handheld cellular phone, a mobile phone, a smart phone, a handheld device having a wireless connection capability, or any other electronic device. In one example, the user device 102 may be configured to browse online shopping websites or access remote servers via a network. In various embodiments, the user device 102 may comprise a browser that provides the ability to browse such websites and interact with other website sites (e.g., the third-party payment websites) on the Internet. The user device 102 may be used to communicate with the online shopping system 104, a login website 106 and/or a retailer website 108. Accordingly, the user device 102 may receive or transmit data, such as product information, login information, and payment information, via a cord or cordless network.

The online shopping system 104, according to exemplary embodiments disclosed herein, may be configured to facilitate online shopping at multiple retailer websites using a single login identifier. More specifically, the online shopping system 104 may provide one or more interfaces for various online retailers such that the online shopping system 104 acts as an intermediate between users and various retailer websites 108. The interfaces may virtually embed various product information related to different online retailers within a single platform such as a single website.

The online shopping system 104 may be configured to receive and process user login information related to any login website 106 in order to retrieve unique internal user login identifiers and generate shared shopping carts based thereon. For this purpose, the online shopping system 104 may be configured to receive (or retrieve) and process login information related to any login website 106 including login identifiers. Based on this information, the online shopping system 104 may then retrieve unique internal user login identifiers to generate shared shopping carts.

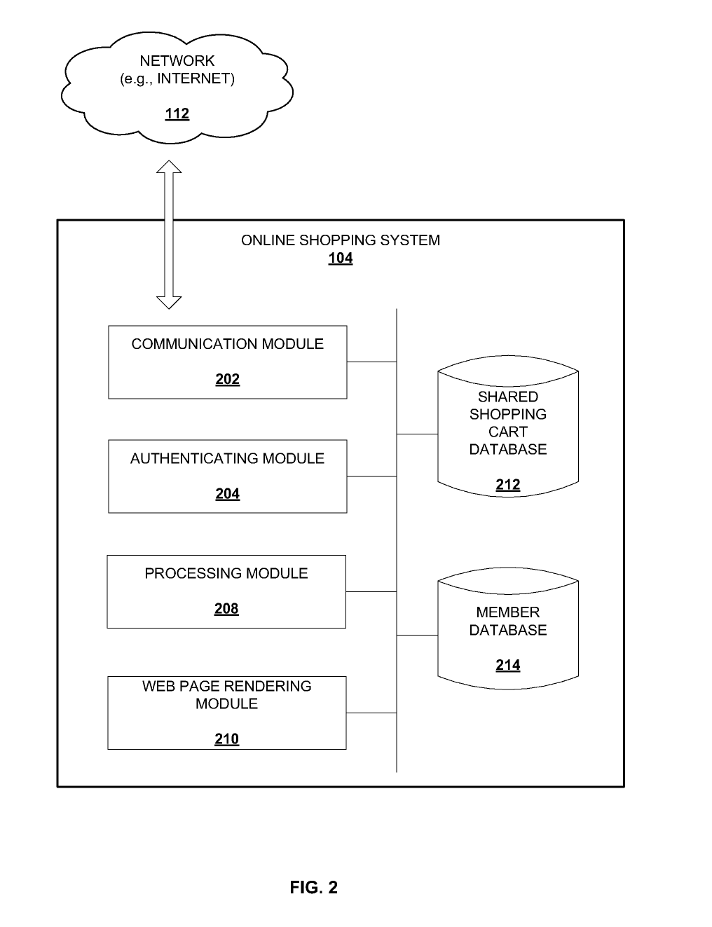

The online shopping system 104 may be implemented on a server that has multiple modules and databases. Furthermore, the online shopping system 104 may host a website that provides the functionality for online shopping using a single shopping cart as described herein. One such example is described in detail below with reference to FIG. 2.

The login websites 106 may relate to any possible social media sites, social networking sites, blogs, micro-blogs, podcasts, chats, gaming websites, news feed sites, and other sites, which maintain membership information about their visitors and have login options. Typically, the login websites 106 are those websites that are commonly visited by users on a regular basis. In some exemplary embodiments, once a user is logged into a login website 106, the online shopping system 104 may determine this fact and retrieve the login information or login-related information, such as member's name.

Retailer websites 108 may include any website dedicated to selling products or services, which evokes the physical analogy of buying products or services at a bricks-and-mortar retailer or a shopping center. Particular examples of retailer websites 108 may include an online shop, e-shop, e-store, internet shop, webshop, webstore, online store, virtual store, and so forth. Typically, the retailer websites 108 require prospective consumers to register and provide personal information, contact information, mailing and billing addresses, payment information, or the like. Accordingly, the retailer websites 108 may transact directly with user devices 102 using direct retail methods and their dedicated shopping carts. In various exemplary embodiments disclosed herein, the retailer websites 108 may transact via the login websites 106. More specifically, the retailer websites 108 may be configured to provide an appropriate virtual interface through one or more login websites 106.

The third-party payment processing system 110 may be used by the online shopping system 104 to process payments based on the information contained in the shared shopping cart. More specifically, the third-party payment processing system 110 may relate to a financial institution's server, including a banking server, a clearing server, a credit/debit/prepaid card server, a virtual account server, an on-line banking server, and so forth. In this disclosure, the term “financial institution” means any organization in the business of transacting money and providing financial services. Financial institutions, such as commercial banks, provide services related to the establishment of bank accounts, cash withdrawals and deposits, issuing of credit cards, debit cards, and so forth. A financial institution's server may be associated with user payment cards (such as credit, debit or prepaid cards), and it may be used to make payments by cardholders and/or receive payments from any organizations or individuals.

FIG. 2 is a diagram of online shopping system 104 according to an exemplary embodiment. The online shopping system 104 may host a website suitable for online shopping and may be operatively connected to the login websites 106, the retailer websites 108, and third-party payment processing systems 110 via the network 112. In some embodiments, a website suitable for online shopping may be built on top of the one or more login websites 106.

In the embodiment shown in FIG. 2, the online shopping system 104 may comprise a communication module 202, an authenticating module 204, a processing module 208, a web page rendering module 210, a shared shopping cart database 212, and a member database 214. In other embodiments, the online shopping system 104 may include additional, fewer, or different modules for various applications. Furthermore, all modules may be integrated within a single system (e.g., a web server), or, alternatively, may be remotely located and optionally accessed via a third party.

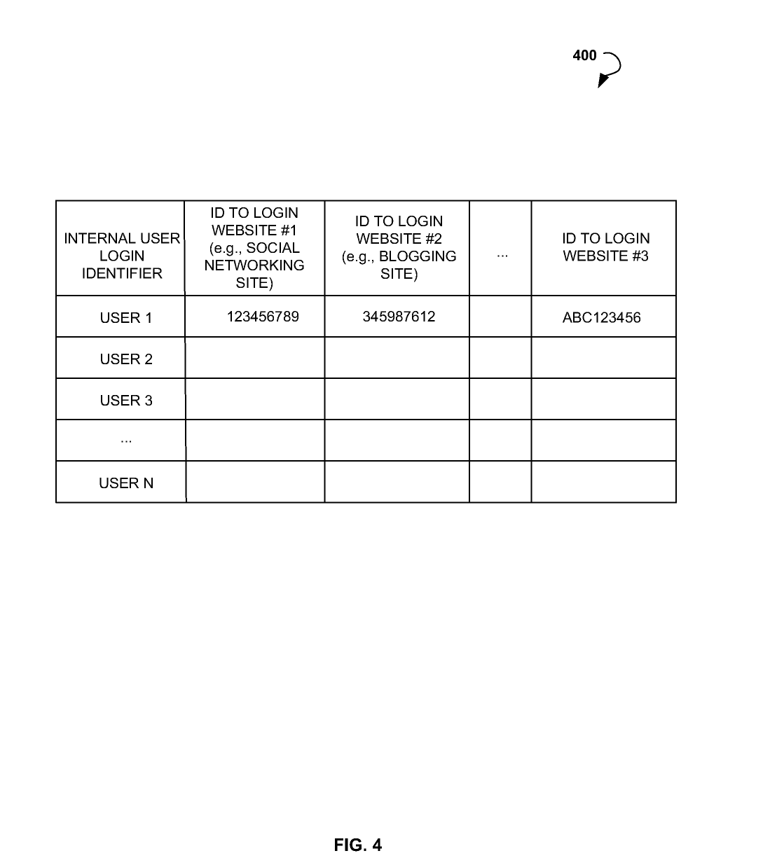

According to exemplary embodiments, the users may be registered with one or more login websites 106 and have corresponding member profiles. In addition, the users may be also registered with the online shopping system 104. Membership profile details related to various login websites 106 and/or the online shopping system 104 may be stored in the member database 214 within the online shopping system 104. Membership profile details stored in the member database 214 may relate to personal information, such as a name, a nickname, user credentials, payment information, billing and/or shipping addresses, a phone number, an e-mail address, credentials of associated member profiles of social media sites, or any other form of contact and personal information. According to various embodiments disclosed herein, the membership profiles stored within the online shopping system 104 may include data concordance tables for multiple membership profiles data. Such concordance tables, as shown, for example, in FIG. 4, may provide information on the correspondence between the internal user identifiers used within the online shopping system 104 and the various membership details related to login websites 106 and/or retail websites 108.

When the users add product items to their shopping carts, information about these product items may be uploaded to the shared shopping cart database 212. This information may be retrieved and modified during a login session. Furthermore, the information from the shared shopping cart database 212 may be forwarded to online retailers to inform them about the products being added to the shopping carts. The retailers may choose or be required to reserve product items once the latter are added to the shopping carts.

The communication module 202 may be configured to connect the online shopping system 104 to the one or more user devices 102, the one or more login websites 106, the one or more retailer websites 108, and the one or more third-party payment processing systems 110 via the network 112. The connection and data transfer may be provided via an Application Programming Interface (API). The communication module 202 may also be configured to provide the functionality enabling communication between all the modules of the online shopping system 104.

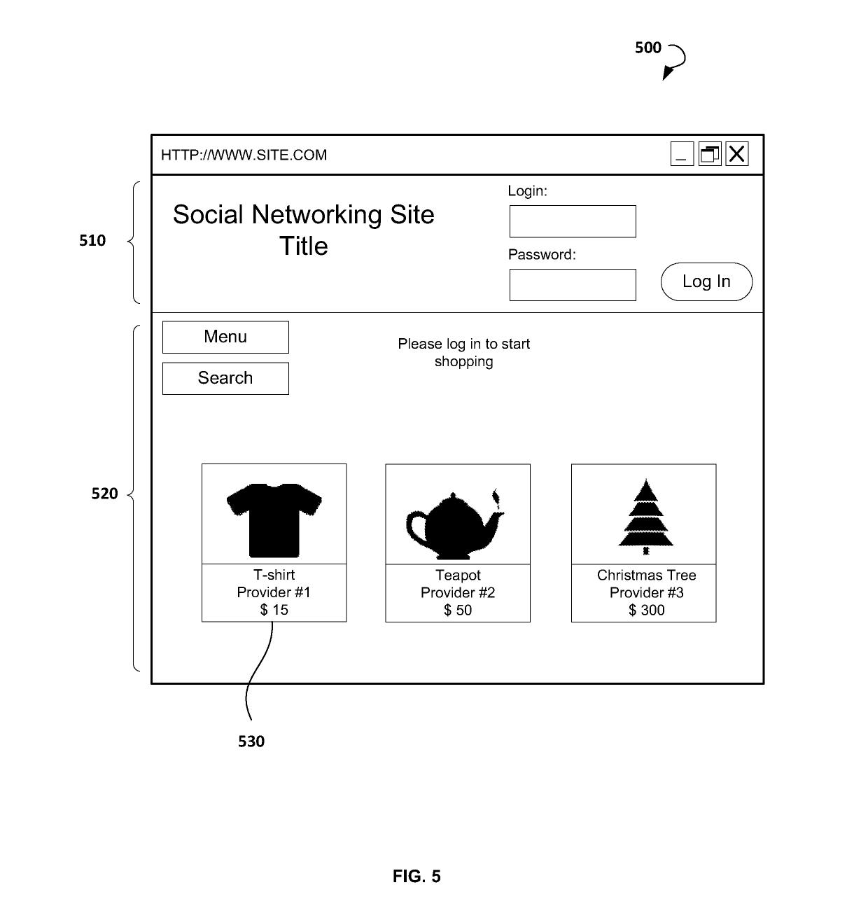

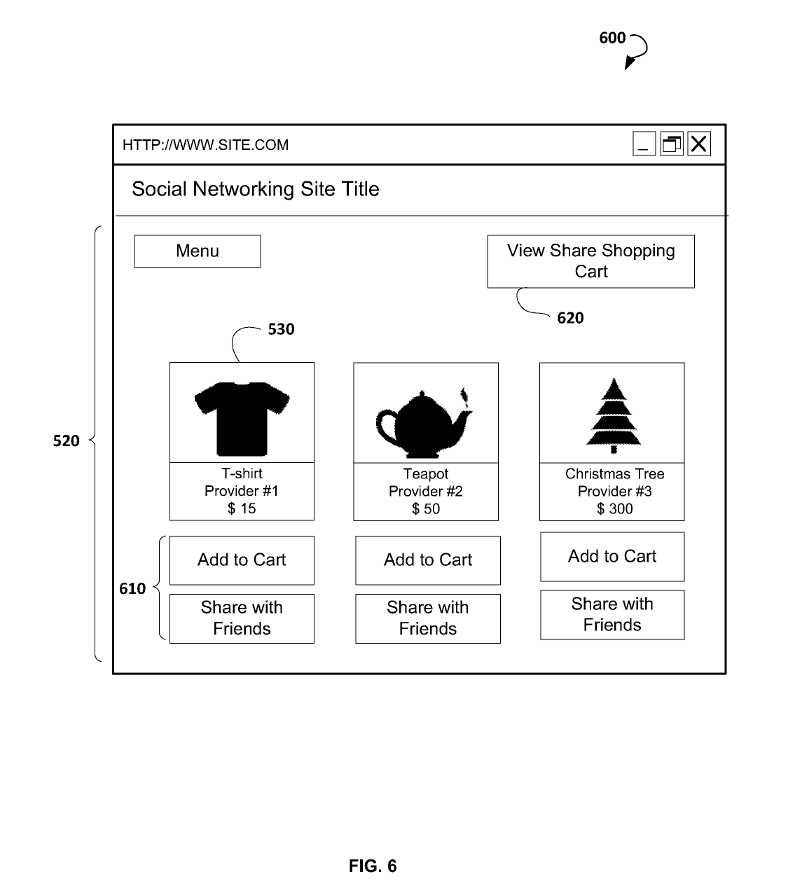

In particular, the communication module 202 may provide a functionality for users to log into the one or more login websites 106 through the website hosted by the online shopping system 104. As mentioned above, this website, which is also referred to as the “online shopping website”, may be built on top of the one or more login websites 106. Possible layouts of the online shopping website are shown in FIGS. 5 and 6. Accordingly, the communication module 202 may receive login information related to the one or more login websites 106. In one example, the communication module 202 may receive a user login and a password. In some other examples, the communication module 202 may receive a user login, membership name, or an identification number only. This may be the case when the user has logged into one or several login websites 106, and then visits the online shopping website hosted by the online shopping system 104 for online shopping using a shared shopping cart. The communication module 202 may retrieve login information from the web cookies stored on the user device, or retrieve this information through an API related to a particular login website 106. In other words, the online shopping system 104 may identify a specific user when they log in to any of the login websites 106 (such as a social networking website or a blogging website) either directly or through the online shopping website. In certain additional exemplary embodiments, the users may log in to the online shopping website directly.

In addition, the communication module 202 may also receive user requests to add product items to the user's shared shopping cart, which, in turn, trigger an update in the shared shopping cart database 212. User requests may include product identifications related to the selections made. In addition, the users may manage member profiles in the member database 214, as well as access and manage the content of the shopping cart in the shared shopping cart database 212. Overall, the communication module 202 may handle all such user requests.

The authenticating module 204 may be configured to authenticate users once their login information is provided. The authentication result may allow other modules to perform their functions relating to successfully authenticated users. The authentication process may be performed internally (i.e., when a user tries to log in to the online shopping site hosted by the online shopping system 104), or externally, i.e., when a user tries to log in to one or more login websites 106. In the latter case, the authenticating module 204 may retrieve the authentication result from the login website 106. Furthermore, the authenticating module 204 may be configured to retrieve an internal user login identifier for each received with login information file, related to the one or more login websites 106.

The processing module 208 may be configured to generate, update, and maintain shared shopping carts based on the user's actions and with respect to internal user login identifiers. The shopping cart may contain some product items from the previous login sessions or contain no items at all. The processing module 208 may monitor the user's actions with respect to particular actions, such as “add to the shopping cart,” and perform various operations accordingly. To this end, the processing module 208 may retrieve information on those product items, which were added by the user to a corresponding shared shopping cart during one or more previous user sessions. Further, the processing module 208 may add such product items to a newly generated shared shopping cart. Accordingly, once the shared shopping cart is generated and the previously added product items are placed into it, the processing module 208 may add new product items to the shared shopping cart. It should be also mentioned that the product items added to the shared shopping cart may be retained in it for a predefined period of time.

The processing module 208 is also configured to analyze the retailer websites 106 to retrieve various product-related information, such as pricing information, product description, and images. This information may be used by the web page rendering module 210 to generate web pages (or their parts), on the online shopping site, dedicated to various product items available through the retailer websites 106. Based on this information, the processing module 208 may generate various product identifiers to be used on the online shopping website and in the shared shopping carts.

Additionally, the processing module 208 may be further configured to receive and process payment information associated with the product items added to the shared shopping cart. In particular, the processing module 208 may send the payment information and the product identification information to the third-party payment system 110 for processing. The payment processing may be implemented for internal user login identifiers associated with the corresponding users.

The web page rendering module 210 may generally be configured to render web pages or some elements of web pages to display product information that corresponds to one or more product items. As mentioned above, the product information may be provided by the processing module 208.

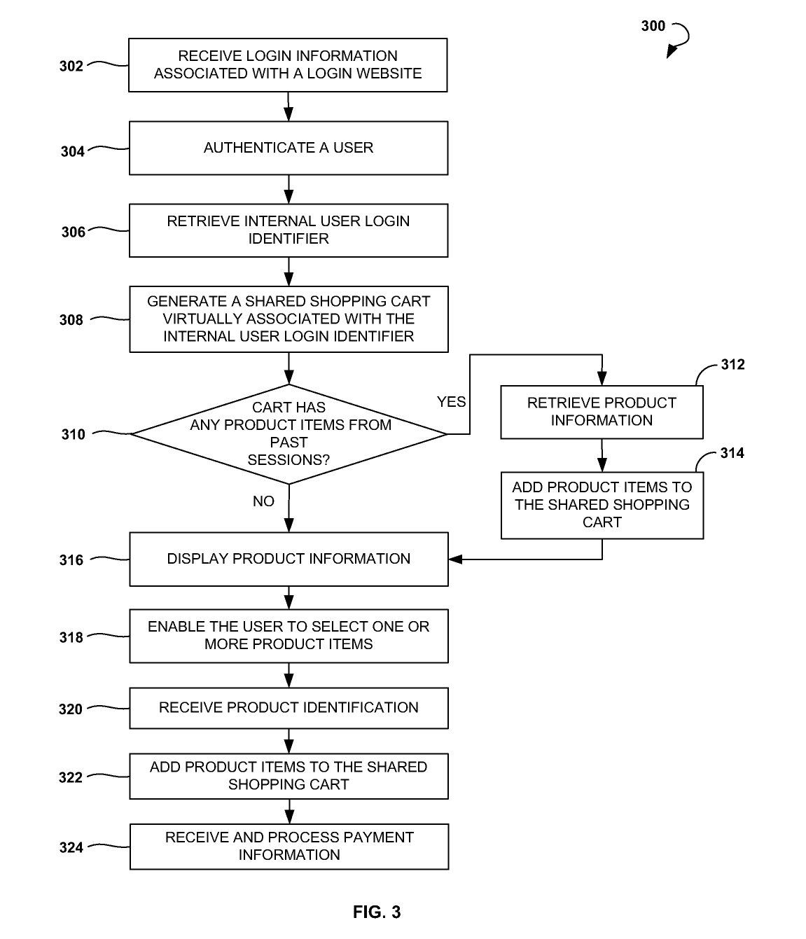

FIG. 3 is a process flow diagram showing a method 300 for facilitating online shopping at multiple retailer websites using a single login identifier, according to an exemplary embodiment. The method 300 may be performed by processing logic that may comprise hardware (e.g., dedicated logic, programmable logic, and microcode), software (such as software run on a general-purpose computer system or a dedicated machine), or a combination of both. In one exemplary embodiment, the processing logic resides at the online shopping system 104.

The method 300 may be applied using the various modules discussed above with reference to FIG. 2. Each of these modules may include processing logic. It will be appreciated by one of ordinary skill in the art that the examples of the foregoing modules may be virtual, and the instructions said to be executed by a module may, in fact, be retrieved and executed by a processor. The foregoing modules may also include memory cards, servers, and/or computer discs. Although various modules may be configured to perform some or all of the various steps described herein, fewer or more modules may be provided and still fall within the scope of the exemplary embodiments.

As shown in FIG. 3, the method 300 may commence at operation 302 with the receipt of the login information related to a login website 106. As stated above, the login information is allocated to a specific user. The login information may be received either from a user device 102, when the user visits the online shopping site hosted by the online shopping system 104, or from a login website 106. At operation 304, the authenticating module 204 may optionally authenticate the received login information. The authentication may be implemented by comparing the obtained login information with the information stored in the member database 214, or by retrieving the authentication information from the corresponding login website 106. At operation 306, the authenticating module 204 may retrieve an internal user login identifier from the member database 214 based on the previously received and authenticated login information. The internal user login identifier uniquely identifies a specific user, his or her personal information, payment information, the shared shopping cart associated with this user, the product items added to the shared shopping cart, and other information.

The method 300 may further involve an operation 308 when the processing module 208 generates a shared shopping cart virtually associated with the internal user login identifier. As mentioned above, the shared shopping cart may be configured for purchasing product items from multiple retailer websites. Once the shared shopping cart is generated during each new session, at operation 310, the processing module 208 may determine whether or not the user has added (selected) one or more product items to the shared shopping cart during the past sessions.

If it is determined at the operation 310 that one or more product items have been added to the shared shopping cart, the method 300 may proceed to operation 312 when the online shopping system 104 retrieves the information on at least one product item which was previously added by the user to the shared shopping cart during one or more previous user sessions. At operation 314, such product items are added to the shared shopping cart.

When it is determined that the shared shopping cart was not updated with any products during the last user sessions, or when the operations 312 and 314 are completed, the method 300 proceeds to operation 316 when at least one product item is displayed to the user. The displaying may be performed through the generation of a web page, or through the customization of the graphic user interface (GUI), associated with the online shopping site. Either of these processes may be performed using the web page rendering module 210.

The method 300 may involve an operation 318 during which logged in users may select and purchase one or more product items from the online shopping website. When a user selects a product item, the product identification information is sent to the online shopping system 104. At operation 320, the communication module 202 of the online shopping system 104 receives the product identification information that corresponds to the selected product items. The product identification information is associated with the unique internal login identifiers of a specific user. At operation 322, the product items associated with the product identification information are virtually added to the shared shopping cart. In some exemplary embodiments, these product items are retained in the shared shopping cart for a predefined period of time.

The method 300 may also involve an operation 324 in which the online shopping system 104 receives and processes payment information associated with the product items added to the shared shopping cart. In particular, these processes may include sending the payment information and the product identification information to a third-party payment system 110 for further processing. Once the product items are paid for by the user, they may be shipped and delivered to the user.

FIG. 4 shows an exemplary embodiment of a concordance table 400 used in the member database 214. The concordance table 400 provides information on the correspondence between the internal user login identifiers used within the online shopping site hosted by the online shopping system 104, and the login identifiers used in various login websites 106. The concordance table 400 may be used by the online shopping system 104 to automatically identify users when they are logged in to one of the login websites 106.

FIG. 5 is a simplified illustration of a graphical user interface 500 of the online shopping site hosted by the online shopping system 104 according to an exemplary embodiment. The graphical user interface 500 may be implemented as a window (e.g., a browser window) to show the site's contents. In one example, the graphical user interface 500 may be shown on a screen of the user device 102 via the browser 114.

By way of example and not limitation, the graphical user interface 500 shows a storefront web page having a login section 510 related to a login website 106 and configured to prompt users to enter their credentials used for the login website 106. Once a login and a password are provided by the user, the online shopping system 104 may identify the user and grant access to the functionality for viewing product items and making purchase decisions. Accordingly, as shown in FIG. 5, when the user is not logged in to the login website 106, the user may only review product sections 520, various product items 530, and the available related information.

The sections 510, 520, and 530 may include widgets, which, in turn, relate to one or more of the actionable buttons, radio buttons, cycle buttons, controls, icons, hyperlinks, text boxes, list boxes, check boxes, images, videos, and so on. Those skilled in the art will appreciate that the graphical user interface 500 may include additional, fewer, or different sections depending on the application.

FIG. 6 is a simplified illustration of a graphical user interface 600 of the online shopping site hosted by the online shopping system 104 according to another exemplary embodiment. The graphical user interface 600 may be implemented as a window (e.g., a browser window) to show its content. In one example, the graphical user interface 600 may be shown on the screen of a user device 102 via the browser 114.

More specifically, the graphical user interface 600 shows a storefront webpage similar to those shown in FIG. 5, but during the time when the user is logged in to a login website 106. In this case, the user is provided with the functionality to review the various product items 530, add them to a shared shopping cart (see section 610), share information with their social network friends, and so on. The user may also review the shared shopping cart through a section 620 and, optionally, make a purchase decision, providing their payment information.

Those skilled in the art will appreciate that the graphical user interface 600 may include additional, fewer, or different sections depending on the application.

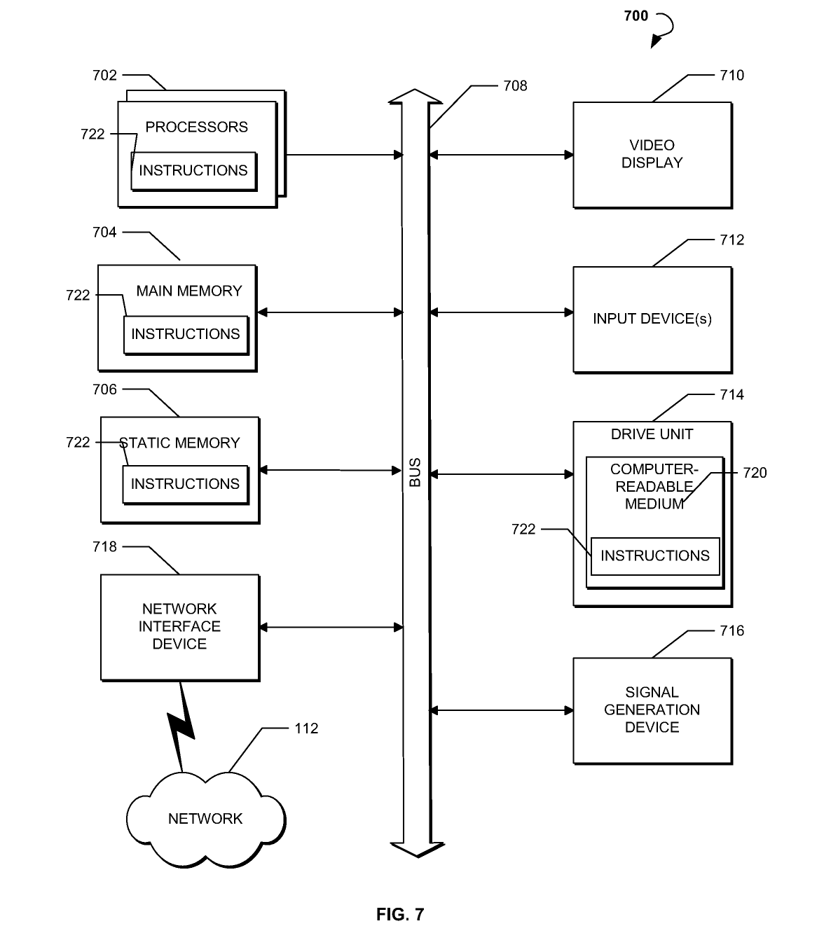

FIG. 7 shows a diagrammatic representation of a computing device for a machine in the exemplary electronic form of a computer system 700, within which a set of instructions for causing the machine to perform any one or more of the methodologies discussed herein may be executed. In exemplary embodiments, the machine operates as a standalone device, or it may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a PDA, a cellular telephone, a portable music player (e.g., a portable hard drive audio device, such as an Moving Picture Experts Group Audio Layer 3 (MP3) player), a web appliance, a network router, a switch, a bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 700 includes a processor or multiple processors 702 (e.g., a central processing unit (CPU), a graphics processing unit (GPU), or both), and a main memory 704 and a static memory 706, which communicate with each other via a bus 708. The computer system 700 may further include a video display 710 (e.g., a liquid crystal display (LCD) or cathode ray tube (CRT)). The computer system 700 also includes at least one input device 712, such as an alphanumeric input device (e.g., a keyboard), a cursor control device (e.g., a mouse), a microphone, a digital camera, a video camera, and so forth. The computer system 700 also includes a disk drive unit 714, a signal generation device 716 (e.g., a speaker), and a network interface device 718.

The drive unit 714 includes a computer-readable medium 720, which stores one or more sets of instructions and data structures (e.g., instructions 722) embodying or utilized by any one or more of the methodologies or functions described herein. The instructions 722 may also reside, completely or, at least, partially, within the main memory 704 and/or within the processors 702 during execution thereof by the computer system 700. The main memory 704 and the processors 702 also constitute machine-readable media.

The instructions 722 may further be transmitted or received over the network 112 via the network interface device 718, using any one of a number of well-known transfer protocols (e.g., Hyper Text Transfer Protocol (HTTP), CAN, Serial, and Modbus).

While the computer-readable medium 720 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the machine, and which causes the machine to perform any one or more of the methodologies of the present application, or which is capable of storing, encoding, or carrying data structures utilized by, or associated with such a set of instructions. The term “computer-readable medium” shall accordingly be taken to include, but not be limited to, solid-state memories, optical and magnetic media. Such media may also include, without limitation, hard disks, floppy disks, flash memory cards, digital video disks, random access memory (RAM), read only memory (ROM), and the like.

The exemplary embodiments described herein may be implemented in an operating environment that comprises computer-executable instructions (e.g., software) installed on a computer, in hardware, or in a combination of software and hardware. The computer-executable instructions may be written in a computer programming language or they may be embodied in firmware logic. If written in a programming language conforming to a recognized standard, such instructions may be executed on a variety of hardware platforms and for interfaces to a variety of operating systems. Although not limited thereto, computer software programs for implementing the present method may be written in any number of suitable programming languages such as, for example, Hypertext Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Perl, UNIX Shell, Visual Basic or Visual Basic Script, Virtual Reality Markup Language (VRML), ColdFusion™ or other compilers, assemblers, interpreters or other computer languages or platforms.

Thus, methods and systems for facilitating online shopping at multiple retailer websites using a single login identifier have been described. The disclosed technique provides a useful tool to enable users to easily purchase product items from multiple retailer websites within a site built, for example, on top of a social networking site, without the necessity to remember multiple different login identifiers and passwords for various online retailers.

Although the embodiments have been described with a reference to specific exemplary embodiments, it will be evident that various modifications and changes may be made to these exemplary embodiments without departing from the broader spirit and scope of the present application. Accordingly, the specification and drawings are to be regarded in an illustrative rather than a restrictive sense.

1. A computer-implemented method for facilitating online shopping from multiple retailers using a single internal user login identifier, the method comprising:
receiving login information from a user device, the login information corresponding to one or more login websites;
retrieving an internal user login identifier based on the login information, wherein the internal user login identifier is independent of the user device;
authenticating a user on the one or more login websites based on the internal user login identifier without the use of a web cookie; and
generating a shared shopping cart associated with the internal user login identifier, the shared shopping cart being configured to facilitate purchasing product items from multiple retailers.

2. (canceled)

3. The method of claim 1, further comprising retrieving information of at least one product item, the at least one product item being entered by the user into the shared shopping cart during one or more previous sessions.

4. The method of claim 3, further comprising adding the at least one product item to the shared shopping cart.

5. The method of claim 1, further comprising displaying product information corresponding to one or more product items based on the internal user login identifier.

6. The method of claim 1, further comprising:
receiving one or more product identifications from at least one retailer website, the product identifications corresponding to the internal user login identifier; and
adding the one or more product items associated with the product identifications to the shared shopping cart.

7. The method of claim 6, wherein the product item is retained in the shared shopping cart for a predetermined period of time.

8. The method of claim 1, further comprising receiving and processing payment information associated with the product items entered into the shared shopping cart.

9. The method of claim 8, wherein receiving and processing the payment information comprises sending the payment information and the product identification information to a third party payment system for processing.

10. The method of claim 9, wherein the payment information is processed based on the internal user login identifier.

11. The method of claim 1, wherein the one or more login website is a social media website or a social networking website.

12. A system for facilitating online shopping from multiple retailers using a single internal user login identifier, the system comprising:
a communication module configured to receive login information from a user device, the login information corresponding to one or more login websites;
an authenticating module configured to retrieve an internal user login identifier based on the login information and authenticate a user on the one or more login websites based on the internal user login identifier without the use of a web cookie, wherein the internal user login identifier is independent of the user device; and
a processing module configured to generate a shared shopping cart virtually associated with the internal user login identifier, the shared shopping cart being configured to facilitate purchasing product items from multiple retailers.

13. (canceled)

14. The system of claim 12, wherein the processing module is further configured to retrieve information of at least one product item entered by the user into the shared shopping cart during one or more previous sessions.

15. The system of claim 14, wherein the processing module is further configured to add the at least one product item to the shared shopping cart.

16. The system of claim 12, further comprising a webpage-rendering module configured to display product information corresponding to one or more product items based on the internal user login identifier.

17. The system of claim 12, wherein
the communication module is further configured to receive one or more product identifications from at least one retailer website, the product identifications corresponding to the internal user login identifier; and
the processing module is further configured to add the one or more product items associated with the product identifications to the shared shopping cart.

18. The system of claim 17, wherein the product item is retained in the shared shopping cart for a predetermined period of time.

19. The system of claim 12, wherein the processing module is further configured to receive and process payment information associated with the product items entered into the shared shopping cart.

20. The system of claim 19, wherein the processing module is further configured to send the payment information and the product identification information to a third party payment system for processing.

21. The system of claim 20, wherein the payment information is processed based on the internal user login identifier.

22. The system of claim 12, wherein the one or more login website is a social media website or a social networking website.

23. A non-transitory computer-readable medium having instructions stored thereon, which when executed by one or more computers, cause the one or more computers to:
receive login information from a user device, the login information corresponding to one or more login websites;
retrieve an internal user login identifier based on the login information, wherein the internal user login identifier is independent of the user device;
authenticate a user on the one or more login websites based on the internal user login identifier without the use of a web cookie; and
generate a shared shopping cart virtually associated with the internal user login identifier, the shared shopping cart being configured to facilitate purchasing product items from multiple retailers.
